(19) United States
(12) Patent Application Publication
(10) Pub. No.: US 2012/0196003 A1
(43) Pub. Date: Aug. 2, 2012

(54) Natamycin-Cyclodextrin Complexes For Use In Foodstuff, Process For Their Manufacture And Use Thereof

(76) Inventors: Torben Snabe, Brabrand (DK); Brett Wesley Thompson, New Century, KS (US); Steven L. Mallory, New Century, KS (US)

(21) Appl. No.: 13/016,230

(22) Filed: Jan. 28, 2011

(51) Int. Cl. A21D 15/08; A21D 13/00; A01P 3/00; A01N 43/90; C08B 37/16

(52) U.S. Cl. 426/94; 514/31; 536/6.5

(57) ABSTRACT

The present invention concerns a process for improving the preservation of a bakery product by natamycin. A composition comprising natamycin in the form of a natamycin-cyclodextrin complex is provided and the composition is applied onto a bakery product as an antifungal agent. The invention also concerns a bakery product comprising an effective antifungal amount of natamycin. Another aspect of the invention is an antifungal natamycin composition and the use thereof, which composition has a modified antifungal activity. Further, the invention concerns a process for modifying the antifungal activity of natamycin.

### RELATED APPLICATIONS AND INCORPORATION BY REFERENCE

All documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The invention concerns natamycin-cyclodextrin complexes, the manufacture and use thereof. Especially the invention concerns a process for improving the preservation of a bakery product by natamycin.

### BACKGROUND OF THE INVENTION

Various methods are used for treating and handling food products to improve their preservation i.e. stop or greatly slow down spoilage caused by micro-organisms, such as yeasts or other fungi. The most appropriate methods vary depending on the food stuff.

As regard to bakery products, many industrially produced baked goods emerge from the baking process with a surface that is essentially sterile, but post bake handling can quickly lead to fungal surface contamination as a result of exposure to air borne contaminants as well as equipment contact. Bakery products with a relatively neutral pH, high moisture content and high water activity such as bread, cakes, muffins, waffles, and tortillas are particularly prone to rapid spoilage from a variety of moulds, principally Penicillium and Aspergillus species. Manufacturing good tasting, high moisture products with a long mould free shelf life presents a constant and ongoing technical challenge to the baking industry. The potential spoilage results in a significant number of returns from retailers within shelf life to prevent customer complaints, adding to the cost of quality at manufacturer.

Various methods have been adopted in an attempt to achieve the required shelf life of food products such as bakery products. These include addition of humectants to reduce the water activity, addition of chemical mould inhibiting preservatives such as propionates or sorbates into the products limiting the availability of oxygen via modified atmosphere packaging and active packaging containing oxygen scavengers or providing a saturated ethanol headspace in the pack using sachet or strip inserts containing ethanol. The chemical preservatives such as sorbate and propionate have the best effect at low pH, so acids are often added in combination with these preservatives to reduce the pH of the bakery product and hence improve the effectiveness of the added preservative. However, addition of acids, chemical preservatives and humectants can affect the flavor and quality of the product, therefore their use is often a compromise between achieving the best tasting product and the longest possible shelf life. Preservation based on packaging systems rely very much on pack integrity and even the best systems can suffer shelf life failures due to pack damage or seal failures and hence loss of pack integrity. Thus, the use of acids, chemical preservatives and humectants does not solve the problem of providing an efficient preservation system, which will not adversely affect the flavor of the food product.

Natamycin is a polyene macrolide natural antifungal agent produced by fermentation of the bacterium Streptomyces natalensis. Natamycin (previously known as pimaricin) is effective against all yeasts and moulds with most strains being inhibited by concentrations of 1-40 ppm of natamycin.

Natamycin has been used for many years in a large number of countries throughout the world as an authorized preservation treatment for cheeses and certain meat products such as dried sausages. Despite this long-term use, the development of resistant strains has not been reported to date unlike the chemical organic acid sorbate and propionate preservatives for which a number of resistant yeasts and moulds have been detected and reported.

The effectiveness of natamycin at very low application levels on cheese and sausage has not been reported to have any adverse quality or flavor impact on the products. Although natamycin has been used for a long time on cheese and on sausages, there is less reported on the use of natamycin for other types of food.

US 2004/0013781 relates to a fully baked bread product which remains soft for an extended shelf life. The bread may be protected by a microbial inhibitor which may be natamycin. In the described embodiments the inhibitor is included in the dough at baking. However, there is also a suggestion that a potassium sorbate inhibitor may be sprayed in an aqueous solution on the bread after baking.

Natamycin has been proposed for use for increasing the shelf life of fine bakery products which have an intermediate or high moisture (US 2005/0163895).

US 2006/0165857 relates to a bakery product which is protected by natamycin against spoilage, said natamycin being evenly distributed on the surface on an effective amount to inhibit the mould growth.

US 2005/0042341 A1 relates to a natamycin dosage form for the food industry, more particularly microcapsules where natamycin is encapsulated within a physiologically acceptable shell.

WO 2008/110531 A1 relates to a process for spraying natamycin onto bakery products and use of heat for the removal of solvent from baked products.

Formation of inclusion compounds with cyclodextrins can modify the physical and chemical properties of a guest molecule, mostly in terms of water solubility. Cyclodextrins (CDs) are constituted by a number of glucopyranoside units. The interior of the molecule is able to host hydrophobic molecules such as natamycin.

Koontz et al. studied natamycin and its cyclodextrin inclusion complexes (J. Agric. Food Chem. 2003, 51, pages 7106-7110 and 7111-7114). They came to the conclusion that the complexes allowed large improvements in the aqueous solubility of natamycin without significant modification of its original structure or antifungal activity, which was evaluated by performing minimum inhibitory concentration (MIC) studies. However, the tests did show an increase of one MIC level for the natamycin-gamma-CD complex. In the study beta-CD, hydroxy propyl beta-CD and gamma-CD natamycin complexes were prepared by dissolving 16 mM, 70 mg and 70 mg respectively of the CDs in water and adding natamycin in great excess of its intrinsic solubility at concentrations of 2.0 g/l, 6.0 g/l and 5.0 g/l respectively. The suspensions were ultrasonicated and stirred rapidly for 48 h and subsequently filtered through a membrane. The obtained solutions were lyophilized to obtain powders. Samples with natamycin concentrations of 0.4-25 μg/ml were prepared from the powders.

Cevher et al. studied the preparation and characterization of natamycin in gamma-cyclodextrin inclusion complexes for formulations of vaginal bioadhesive tablets (J. Pharm. Sci. 2008, Vol. 97, pages 4319-4335). The conclusion of the studies was that the complexes improved the solubility of natamycin without modifying its antimyotic activity. The complexes of natamycin and gamma-cyclodextrin were prepared by adding the stoichiometric 1:1 amount of natamycin to an aqueous solution of gamma-cyclodextrin. The suspensions were shaken for 7 days and finally filtered. The filtrates were lyophilized and the formed natamycin-gamma-cyclodextrin complexes were used in formulations of vaginal bioadhesive tablets.

The publication CN101491240 relates to a preparation method for natamycin-cyclodextrin supermolecule clathrate with cyclodextrin and derivatives. The method involves keeping the bacteriostatic activity of natamycin and improving the water solubility and stability of natamycin. The method relates to preparing an aqueous solution of the cyclodextrin and the derivatives through ultra pure water, adding a certain amount of natamycin into the aqueous solution, and carrying out ultrasonic treatment for 5 minutes, and covering a layer of aluminum-foil paper on the container of the suspension, placing the container on a shaking table at a room temperature for reaction.

U.S. Pat. No. 4,883,785 relates to complexes of an antifungal agent and cyclodextrin. The complex which includes amphotericin B has improved water solubility and stability over amphotericin B antifungal agents. Formulations with the complex according to U.S. Pat. No. 4,883,758 are effective in combating infections. It is not suggested that the antifungal activity of the antifungal agent is improved as a result of complexation with cyclodextrin.

V. E. Teter tested the use of cyclodextrins with natamycin in her Master's Thesis “Ensuring the Stability of Natamycin on Shredded Cheese” (Virginia Tech, 24 Aug. 2006). She tested the use of cyclodextrins to increase water solubility of natamycin to see if a uniform distribution of natamycin over shredded cheese could be done effectively. She also performed mould growth prevention tests on shredded cheese. According to her study, there was no difference in the amount of mould free days for the samples treated with dry natamycin, aqueous natamycin suspension, or the natamycin complexed with non-modified cyclodextrin.

The complexation of natamycin with cyclodextrins has been used for improving the water solubility of natamycin. The complexes have been used in various pharmaceutical preparations and tested for the preservation of shredded cheese. The studies showed that the antifungal activity of the natamycin-cyclodextrin complexes was nearly equivalent to that of non-complexed natamycin. Further, the above mentioned methods for forming inclusion complexes of natamycin with cyclodextrins are rather ineffective in terms of complexation time and the degree of complexation.

Natamycin has low water solubility with its maximum solubility being around 40 ppm. Although spraying natamycin onto bakery products has showed successful results as antifungal treatment, the conventional methods still have many drawbacks due to the poor water solubility of natamycin. These drawbacks include the need of constant agitation and the plugging of nozzles during application of the natamycin solution or suspension. The drawbacks contribute to considerable problems with inconsistency in application. Also, the stability of natamycin is affected by factors such as light and oxidation.

Many bakery products are required to have a very long shelf life, e.g. up to 2 to 10 weeks and sometimes longer at ambient temperature. The high water content of many bakery products makes them very sensitive to spoilage due to mould and yeast growth. There is still a continuous need to increase the shelf life of bakery products having a tendency to mould growth whilst optimizing on desirable product characteristics such as pH and flavor.

Citation or identification of any document in this application is not an admission that such document is available as prior art to the present invention.

### SUMMARY OF THE INVENTION

The invention according to the present invention is based on the realization that complexation of natamycin in cyclodextrin improves the preservation of a bakery product. The improved preservation allows the use of lower levels of natamycin. The improved preservation can also be utilized for providing an increased shelf life of the bakery product with natamycin.

An object of the invention is to achieve a solution to, or at least substantially reduce one or more of the above mentioned problems. An object is also providing an efficient process for forming natamycin-cyclodextrin inclusion complexes. A special object of the invention is to bring forth a process for improving the preservation of a bakery product by natamycin.

The objects of the invention may be accomplished with the processes and products having the characteristics as mentioned in the independent claim. The preferred embodiments of the invention are presented in the dependent claims. One object of the invention is thus to provide a process for improving the preservation of a bakery product by natamycin. The process may comprise the steps wherein a composition may comprise natamycin in the form of a natamycin-cyclodextrin complex is provided, and wherein said composition is applied onto said bakery product as an antifungal agent.

The invention also concerns a bakery product which may comprise an effective antifungal amount of natamycin in the form of a composition which may comprise a natamycin-cyclodextrin complex on the surface thereof.

The invention also relates to an antifungal natamycin composition with a modified antifungal activity. The natamycin may be in the form of a natamycin-cyclodextrin complex which is formed through dissolving cyclodextrin and natamycin in an aqueous solution and thereby causing complexation between said cyclodextrin and natamycin. The formed composition is optionally recovered and processed to a powder through spray drying.

Further, the invention concerns a process for modifying the antifungal activity of natamycin. The process may comprise the steps of dissolving cyclodextrin and natamycin in an aqueous solution, causing complexation between said cyclodextrin and said natamycin to provide natamycin-cyclodextrin complexes. Optionally the process may comprise recovering a composition which may comprise said natamycin-cyclodextrin complexes from said aqueous solution. Further the process may comprise processing said composition which may comprise said natamycin-cyclodextrin complexes to a powder through spray drying.

Another object of the invention may be the use of a spray dried natamycin-cyclodextrin composition as an antifungal agent for the preservation of food products.

The present invention provides an improvement over previous methods of spraying natamycin on baked goods. It provides a method wherein less natamycin can be used to obtain the same shelf life of the products as previous described. It also provides a method which allows obtaining a longer shelf life of the product by using the previously used amounts of natamycin. Further, the invention reduces the problems previously encountered during application of the aqueous solution which may comprise natamycin.

Accordingly, it is an object of the invention to not encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1 shows the effect of pH and gamma-cyclodextrin on natamycin solubility,

FIG. 2 shows the effect of pH on natamycin solubility when complexed with gamma-cyclodextrin,

FIG. 3 shows natamycin inhibition results on tortillas after 12 days at 25° C. and 80% RH,

FIG. 4 shows natamycin inhibition results on tortillas after 21 days at 25° C. and 80% RH,

FIG. 5 shows natamycin inhibition results on tortillas after 28 days at 25° C. and 80% RH, and

FIG. 6 shows natamycin inhibition results on tortillas after 36 days at 25° C. and 80% RH.

### DETAILED DESCRIPTION OF THE INVENTION

When natamycin is used in aqueous solutions or suspensions according to the conventional methods the poor water solubility of natamycin causes problems with inconsistency in application. There is a need for constant agitation to keep the natamycin solution or suspension homogeneous. Plugging of nozzles occur during spray application of natamycin due to particles and/or crystallization. Thus it is difficult to find appropriate application methods.

To reduce the problems with inconsistency of application of natamycin on the food products, more natamycin preparation than required must sometimes be used to ensure sufficient antifungal protection on every part of the product. Safety regulations relating to the amounts of preservatives, such as antifungal agents, on food products limit the use of natamycin. Therefore, the amount of natamycin has to be limited, so that no areas of the food products contain too high levels of natamycin. In order to keep a safety marginal, the use is often a compromise between applying enough natamycin on every part and avoiding areas with too high levels of natamycin.

With the present invention, food preservation with the antifungal agent natamycin can be improved. The above mentioned problems leading to inconsistency of application can be reduced with the processes and products of the present invention. A more uniform distribution of natamycin can be achieved and smaller amounts of natamycin can be used. The more uniform distribution, especially when applying natamycin-cyclodextrin compositions in an aqueous solution, is a result of a more homogenous and optionally higher concentration of natamycin in the solution wherein natamycin is in form of natamycin-cyclodextrin complexes. Further, less aqueous solution can be used than in the conventional methods, which reduces the problems with increasing the amount of water on the surface of the product. Adding water onto the product causes problems with an increased risk for mould growth. Moreover, water may destroy the surface texture of bakery products.

Unexpectedly, it has been found that compositions comprising natamycin-cyclodextrin complexes improve the preservation of a bakery product compared to natamycin compositions comprising the natamycin in non-complexed form. The improved preservation allows the use of lower levels of natamycin than in previously described processes. The improved preservation can also be utilized for providing an increased shelf life of the bakery product with previously utilized levels of natamycin.

It has been discovered that the complexation of natamycin with cyclodextrins is inherently tied to the pH value of the solution where the complexation reaction occurs. High pH values improve the efficiency of the reaction process considerably in terms of the complexation time and complexation level compared to previous processes. Low pH values also improve the efficiency of the reaction process considerably. This is a surprising finding since natamycin by itself is rapidly degraded in alkaline and in acidic aqueous solutions.

Studies were done wherein aqueous solutions of natamycin-cyclodextrin complexes have been applied onto shredded cheese or used in pharmaceutical preparations. Previous studies showed that the formation of natamycin-cyclodextrin inclusion complexes did not modify the antifungal activity of natamycin on shredded cheese. In the present invention it has surprisingly been found that when applying natamycin-cyclodextrin complexes onto bakery products the preservation of the products can be improved. The antifungal activity per unit of applied natamycin increased when natamycin was complexed with cyclodextrin compared to natamycin alone. Tests indicate that applying the cyclodextrins alone on baked goods shows no antifungal activity. It was also discovered that simply mixing gamma-cyclodextrin and natamycin together in solution and applying it onto baked goods did not give the same level of antifungal activity. Further steps were required to form the natamycin-cyclodextrin complexes in high enough concentrations to achieve the maximum desired effect on baked goods.

In connection with the present invention studies have shown that applying the composition comprising natamycin-cyclodextrin complex onto other food products, such as cheese and sausage, did not have the same effect as when the complex was applied on bakery products.

In the present specification and claims, the following terms and expressions may have the meanings defined below.

A “bakery product” according to the present invention can be made from dough which may be yeast leavened or non-yeast leavened, such as baking powder raised bread. The bakery product is typically selected from artisan bread, bagels, baguette, biscuits, bread loaves, brownies, buns, burger rolls, cakes, cookies, cornmeal, crackers, crepes, cookies such as bar type including toffee, lemon, date, fig and fruit filled cookies, croissants, crumpets, Danish pasty, flat bread, French toast, fruit bread, khari, laminated doughs, moon cakes, muffins, naan, namkeens, nankatais, pan bread, pancakes, pastries including eclairs, cream puff and doughnuts, pies, pita bread, pizza or pizza crust, quick bread, rolls, rye bread, sandwich pouches, scones, sweet dough, sweet rolls, tin bread, toast, tortillas, waffles, wheat bread, whole-wheat bread or yeast raised high moisture specialty breads, including added fiber, low calorie, English muffins. Most typically the bakery product may be yeast raised bread including rolls, sweet rolls, bagels, croissants and pizza crust; flat bread, including naan and pita bread; yeast raised high moisture specialty bread; baking powder raised bread, including biscuits, scones, muffins, cornmeal and quick bread; crumpets; sweet ready-to-eat baked goods including cakes, cheesecake, pies and pastries, or tortillas. The bakery product may be baked, semi-baked, parbaked, pre-baked or non-baked. Also frozen bakery products are included in the definition of bakery product according to the present invention. However, such products may be sufficiently preserved by the freezing rather than by a chemical preservative.

An “antifungal agent” is a compound that prevents or retards the growth of certain micro-organisms, such as yeast or fungi. Natamycin is an antifungal agent. The expression “effective antifungal amount” or variations thereof, is used herein to mean an amount of natamycin, which is sufficient in preventing or retarding micro-organism growth.

The expression “modified antifungal activity” as used in connection with natamycin refers to a natamycin composition, which has an antifungal activity which differs in one or more respects from that of natamycin alone. The compositions comprising natamycin-cyclodextrin complexes of the present invention have a modified antifungal activity, which is shown for example in that aqueous solutions of said composition which are applied on bakery products are more potent than the same amount of non-complexed natamycin applied on said bakery products. It is believed that the modified antifungal activity of the compositions comprising natamycin-cyclodextrin complexes prepared with the method according to the present invention allows more of the applied natamycin molecules to act as antifungals, compared to natamycin used in non-complexed form. “Modifying the antifungal activity” of natamycin in the present invention is performed by the process of the present invention.

“Preservation” is to stop or greatly slow down spoilage of food products caused or accelerated by micro-organisms. This can be done by treating the food products with preservatives, such as antifungal agents.

The term “cyclodextrin” or “CD” refers to cyclic oligosaccharides containing numerous glucose monomers, the most common of which contain six to twelve monomers. The specific coupling and conformation of the glucose units provide the cyclodextrin molecule with a rigid, conical structure, having a hollow interior of a specific volume. The “lining” of the internal cavity is formed by hydrogen atoms and glycosidic bridging oxygen atoms, making this internal surface a fairly hydrophobic region. The unique shape and physical-chemical properties of the cavity enable the cyclodextrin molecules to form inclusion complexes with organic molecules, or parts of organic molecules, which can fit into the cavity.

The expression “natamycin-cyclodextrin complex” or “natamycin-cyclodextrin inclusion complex” refers to a complex molecule with cyclodextrin as a carrier molecule and natamycin as the inclusion molecule. The expression “cyclodextrin-formulated natamycin” or variations thereof also refers to compositions comprising natamycin-cyclodextrin complexes of the invention. The hydrophobic internal cavity of the natamycin molecule is connected to the hydrophobic internal cavity of the cyclodextrin molecule. Both ends of the complex's exterior are polar, or hydrophilic. As water is a polar solvent, the inclusion complex is inherently soluble in aqueous solutions. The process of the present invention provides a significantly more efficient reaction between natamycin and cyclodextrin than previous processes. Consequently, the resulting aqueous solution wherein the complexes are provided has a higher proportion of the natamycin molecules as cyclodextrin inclusion complexes than the corresponding natamycin-cyclodextrin solutions produced according to previous processes. The high complexation rate of the process of the invention enables full utilization of the natamycin introduced into the process. It also provides a natamycin composition wherein at least 50% of the natamycin introduced into the process of the present invention is in complexed form. Typically more than 75% of the natamycin is in complexed form. Ideally 90% or more of the natamycin, such as 95% or more is in complexed form. It is believed that the process of the present invention enables up to 98-100% complexation of the natamycin without the need for removal of non-complexed natamycin from the solution. Previously, a large proportion of the natamycin in the reaction solution remained non-reacted and this non-soluble natamycin typically needed to be removed from the solution.

The expression “natamycin-cyclodextrin composition” refers to compositions containing natamycin-cyclodextrin complexes and also any unreacted natamycin and/or cyclodextrin. The compositions can be in the form of a spray dried powder. The natamycin-cyclodextrin compositions prepared according to the invention typically comprise over 10 weight-% natamycin. Typically the maximum amount of natamycin in the compositions is 30 weight-%. Ideally the compositions comprise 10-25 weight-% natamycin, such as 12-20 weight-%. A minor amount of the natamycin in the composition may be dissolved in non-complexed form. The rest of the composition comprises cyclodextrins and other compounds, such as salt formed during pH adjustments. When preparing the compositions, the molar ratio of natamycin to cyclodextrin is calculated to ensure that enough cyclodextrin has been used to theoretically complex all of the natamycin in the composition. The molar ratio is essentially the same as the mass ratio of the components (natamycin to cyclodextrin). The molar ratio of natamycin to cyclodextrin in the complexation is ideally 1/1, but it is typically higher, such as 1/1 to 1/5, to ensure a high enough amount of cyclodextrin. Ideally the molar ratio of natamycin to cyclodextrin in the complexation is 1/2 to 1/4. The molar and the mass ratio in the composition are within the same ranges.

The expression “aqueous solution” is a solution, wherein water is used as solvent. The solution can also contain other additives, such as liquids or dissolved substances, for example acids and/or bases and salts.

The present invention concerns a process for improving the preservation of a bakery product by natamycin. The process according to the present invention comprises the steps wherein a composition comprising natamycin in the form of a natamycin-cyclodextrin complex is provided, and wherein said composition is applied onto said bakery product as an antifungal agent.

The compositions comprising natamycin in the form of a natamycin-cyclodextrin complex may be processed to a powder by spray drying. The composition comprising natamycin in the form of a natamycin-cyclodextrin complex may be provided in an aqueous solution for the application,

In one embodiment of the invention said composition is applied from an aqueous solution provided by dissolving a spray dried natamycin-cyclodextrin composition in water.

Spray drying is a method of producing a dry powder from a liquid or slurry by rapidly drying with a gas. This process has many benefits, such as efficiency, compared to other drying methods. Spray drying produces particles with a more porous structure than, for instance, freeze drying. Also, spray drying makes it possible to vary the size of the droplets and the temperature, and in that way to improve the consistency of the finished powder. A porous spray dried powder will have a consistency with excellent characteristics in terms of for example solubilization rate, hydration rate and dispersibility when added to water.

In the present invention the compositions comprising the natamycin-cyclodextrin complexes used as an antifungal agent may be used together with one or more antimicrobial agents, which either kill or slow the growth of microbes. The antimicrobial agent can be for example salt, sorbates or benzoates. The compositions may further be used together with a glacing ingredient, which provides a further protecting cover to a bakery product. Said glacing agent can be for example salt, sugar, sugar glacings and egg-based or flavoring glacings.

An embodiment of the process comprises a step wherein the composition is applied onto the bakery product in an effective antifungal amount. The effective amount typically includes 0.1 μg/cm² or more, preferably 0.1 to 7.0 μg/cm², most preferably 0.2 to 0.9 μg/cm² natamycin on the surface of said bakery product. One embodiment of the process of the invention involves applying the composition onto the bakery product after baking. Preferably, the temperature of the baked bakery product is not lower than 50° C. when the composition is applied.

Natamycin is sensitive to the high temperatures used in baking and one option is therefore to apply natamycin after the baking process. If the temperature is not lower than 50° C., the heat from the baked product can provide a way to evaporate the solvent from the surface of the baked product. Spraying an excessive amount of aqueous natamycin onto bakery products should be avoided, since this would result in excessive surface moisture. Ideally, the spraying of natamycin should not increase the moisture of the bakery product, since a higher moisture level increases the risk for mould growth. In the present invention the natamycin composition is typically dissolved in an aqueous solution. However, other types of applications are also possible such as brushing of the dry powder onto the food product or inclusion of the composition comprising the complex into the dough of non-yeast leavened bakery products. For sausages and the like products, dipping is a suitable manner of application.

In one embodiment of the invention said natamycin-cyclodextrin composition is applied onto the bakery product in the form of a pan oil or grease containing said composition. Typically the composition is mixed with the pan oil or grease and the mixture is applied onto the pan prior to baking. Conventional pan release coating equipment may be used. Pan oil or pan grease application can facilitate the overall application of natamycin onto baked goods, also onto the sides and the bottom. This way pan oil or grease application together with other forms of application, such as applying the compositions from an aqueous solution, can provide protection of the whole product.

Complexation of natamycin with cyclodextrin improves the heat stability of the natamycin and the complexes consequently retain a higher antifungal activity after baking than the use of natamycin alone in pan oil or grease.

The invention provides a process for producing a bakery product, the shelf life of which has been increased by applying a composition comprising a natamycin-cyclodextrin complex on the surface thereof. The bakery products are typically intended for a long shelf life. They also typically have a moisture content which makes them susceptible to surface spoilage by moulds and yeasts. Such bakery products are especially baked shaped products having a water activity A_{w} of 0.75-0.95 after cooling.

The invention also concerns a bakery product comprising an effective antifungal amount of natamycin in the form of a composition comprising a natamycin-cyclodextrin complex on the surface thereof. The amount of natamycin on the surface of said bakery product is 0.1 μg/cm² or more, preferably 0.1 to 7.0 μg/cm², most preferably 0.2 to 0.9 μg/cm². The number of days which this amount of natamycin will keep the bakery product mould free varies depending on many factors, for example the product type. Typically this amount is sufficient for keeping the bakery product mould free for a long period of time, such as 2 to 3 weeks and up to 6 weeks, when the product is stored at ambient temperature, which means a temperature between 15 and 30° C. and which typically is from 18 to 25° C.

Another aspect of the present invention is an antifungal natamycin composition with a modified antifungal activity. In this composition said natamycin is in the form of a natamycin-cyclodextrin complex which is formed through dissolving cyclodextrin and natamycin in an aqueous solution, causing complexation between said cyclodextrin and natamycin. Thereafter the thus formed composition is optionally recovered and processed to a powder through spray drying.

In one embodiment the cyclodextrin in said natamycin-cyclodextrin complex comprises beta- and/or gamma-cyclodextrin, preferably gamma-cyclodextrin.

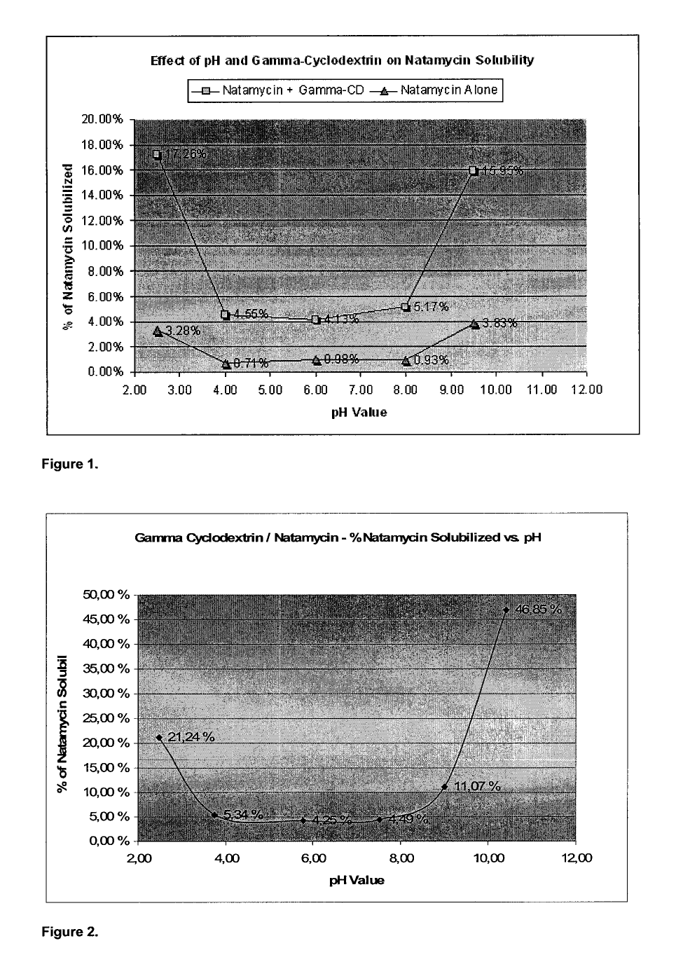

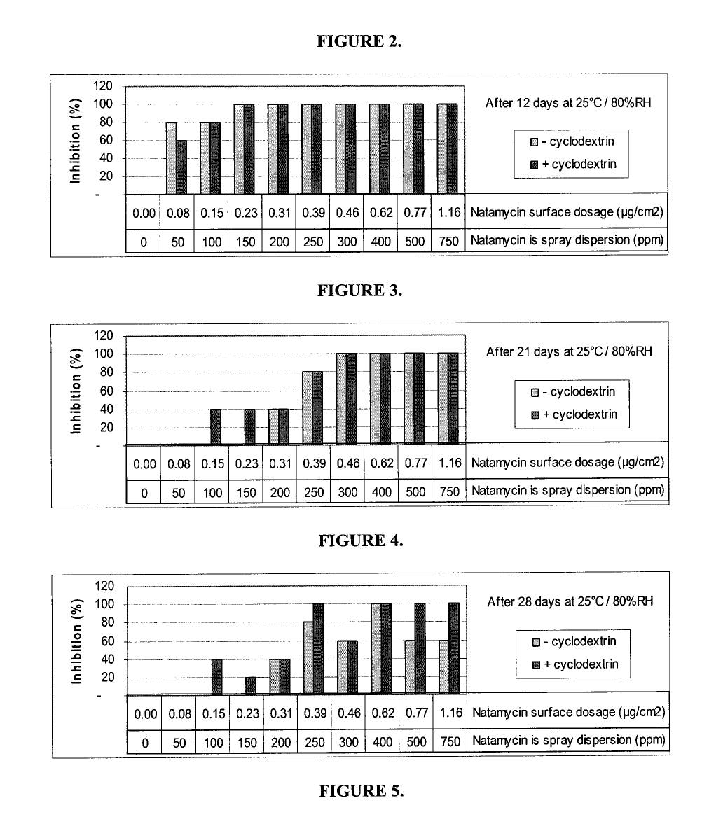

Natamycin is sensitive to both high and low pH values and is degraded under such conditions. Despite this fact, the present invention utilizes such pH ranges. In one embodiment of the invention, the pH value of the aqueous solution in the complexation step is in the range of 8 or higher, preferably 8 to 13, more preferably 8 to 12, when forming the natamycin-cyclodextrin complex of the antifungal composition. Typically the pH value is in the range of 10 to 12. In another embodiment the pH value of the aqueous solution in the complexation step is in the range of 6 or lower, preferably 1 to 4. Typically the pH value is lower than 4, such as in the range of 3 to 4. Studies in connection with the present invention have shown that the formation of a natamycin-cyclodextrin complex is most efficient in aqueous solutions with pH values over 8. The formation of a natamycin-cyclodextrin complex is also efficient at pH values lower than 6. By controlling the pH value and temperature the efficiency can be greatly increased and the length of time needed to get appropriate complexation levels can be reduced. FIG. 1 shows test results of the effect of pH and gamma-cyclodextrin in natamycin solubility compared to natamycin alone (non-complexed). The graph in FIG. 1 shows that the percentage of solubilized natamycin starts to increase at pH values of 6 or lower and also of 8 or higher for natamycin complexed with gamma-cyclodextrin. The graph further shows that the percentages increase significantly at pH values below 3 or above 8, where over 15% of the natamycin is solubilized when complexed with cyclodextrin compared to below 4% for natamycin alone. FIG. 1 shows that already above pH 9 the solubility percentage is as high as 15 to 20%. FIG. 2 shows test results of the effect of pH and gamma-cyclodextrin on natamycin solubility. It can be seen that at pH values above 10 the percentage of solubilized natamycin is considerably higher, such as above 40%, and at pH values below 3 the solubility is above 20%. The tests in FIG. 1 and FIG. 2 were made through mixing natamycin (1%) and cyclodextrin (1%) with water (98%)

In both of the above mentioned embodiments the pH value of the aqueous solution is preferably adjusted to a pH value in the range of 6 to 8 after the complexation. This adjustment is done in order to prevent decomposition of the product. The pH value adjustments can be accomplished by addition of a suitable base or acid. Raising the pH value can be accomplished by adding a base, for example NaOH. Lowering the pH value can be accomplished by adding an acid, for example HCl. During the adjustment of the pH value, the acid and the base react with one another forming a neutral salt. For example NaOH and HCl form NaCl (sodium chloride). The base and the acid should be chosen, so that the salt which is formed through their reaction is non-toxic and approved for use in food products. Alternatively, the base and the acid should be chosen, so that the salt which is formed can be easily removed from the mixture, for example a poorly soluble salt. Ideally, the formed salt is inert to the other reactants. Preferably, the formed salt does not need to be removed from the antifungal composition. If the salt needs to be removed, it can be removed e.g. using chromatography. The natamycin-cyclodextrin complexes may also be recovered from the mixture, for example by precipitating the natamycin-complexes and filtering or centrifuging them for separation from the salt-containing aqueous solution.

Further, the temperature of the aqueous solution in the complexation step of said cyclodextrin and natamycin can be 0 to 100° C., preferably 15 to 30° C. Natamycin is sensitive to heat. Heating or cooling of the reaction mixture is energy consuming and therefore it is an advantage to be able to perform the reaction at ambient temperature.

According to one aspect, the invention also concerns a process for modifying the antifungal activity of natamycin which process comprises the steps of
a. dissolving cyclodextrin and natamycin in an aqueous solution,
b. causing complexation between said cyclodextrin and said natamycin to provide natamycin-cyclodextrin complexes,
c. optionally recovering a composition comprising said natamycin-cyclodextrin complexes from said aqueous solution, and
d. processing said composition comprising said natamycin-cyclodextrin complex to a powder through spray drying.

In one embodiment of the process for modifying the antifungal activity of natamycin the pH value in step b. is in the range of 8 or higher, preferably 8 to 13, more preferably 8 to 12. Typically the pH value is in the range of 10 to 12. In another embodiment the pH value in step b. is in the range of 4 or lower, preferably 1 to 4. Typically the pH value is lower than 4, such as in the range of 3 to 4.

In both of the above embodiments the pH value of the solution formed in step b. is preferably lowered to the range of 6 to 8 after the complexation. The pH value adjustments can be accomplished by addition of a suitable base or acid. Raising the pH value can be accomplished by adding a base, for example NaOH. Lowering the pH value can be accomplished by adding an acid, for example HCl.

The process according to the present invention has improved the efficiency of natamycin-cyclodextrin complexation considerably. The main improvements have been accomplished by controlling the pH value of the aqueous solution in the complexation step of natamycin with cyclodextrin.

A further aspect of the present invention is the use of the spray dried natamycin-cyclodextrin composition, which comprises a natamycin composition with a modified antifungal activity, as an antifungal agent for the preservation of food products. Preferably the food product is a bakery product.

The natamycin-cyclodextrin compositions of the present invention make it possible to distribute the natamycin molecules more evenly on the surface of the food product, for example when applied from an aqueous solution. This way less natamycin is needed to accomplish a better antifungal effect. In a conventional aqueous solution of natamycin a part of the natamycin is in crystalline form, which hinders these natamycin molecules from performing actively as antifungal agents. Studies made in connection with the present invention have shown that natamycin more easily adheres to the hydrophilic surface of given food products, such as bakery products, when it is in complexation with cyclodextrins.

After the composition comprising the natamycin-cyclodextrin complex has been applied onto the bakery product, the product may be sliced, if desired, and then packaged for example into a protective envelope, which is preferably made of a transparent material such as a plastic film or box to allow the presumptive buyer to view the product and be tempted by it. The films are generally of a moisture proof material to prevent the moist bakery product from drying and loosing its softness during the several weeks of storing. Other forms of packaging are also possible depending on the product. During packaging some preservatives, like nitrogen gas can be sprayed into the package. Some bread products are pasteurized after packaging.

The advancements made possible by the present invention have many benefits. They reduce or alleviate the need for equipment used to agitate the natamycin solution thus saving the end-user on equipment costs. They also reduce the number of line stoppages incurred due to plugged nozzles and ensure a more confluent, homogeneous application consistency reducing product returns. Further, data shows that natamycin formulated with a cyclodextrin and applied to bakery goods allows for less natamycin to be used on the finished product, making it easier to comply with the current regulatory standards and approvals. The complexation with cyclodextrins can also protect natamycin from degradation from light and/or oxidation. The result is additional shelf life extension over previously described natamycin treatments, even when used at lower natamycin levels. Finally, the method according to the invention for producing these complexes is far more efficient than what is presently offered.

Natamycin is commercially provided by Danisco A/S by the trade name Natamax®, for example Natamax® SF. Other providers of natamycin are for example DSM Food Specialties BV by the trade name Delvocid®.

Although the present invention and its advantages have been described in detail, it should be understood that various changes, substitutions and alterations can be made herein without departing from the spirit and scope of the invention as defined in the appended claims.

The present invention will be further illustrated in the following Examples which are given for illustration purposes only and are not intended to limit the invention in any way.

### Example 1

### Preparation of Natamycin-Cyclodextrin Complex Compositions

3.25 parts per weight gamma-cyclodextrin and 1 part per weight natamycin were mixed in water. The pH value was raised to 12-12.1 with NaOH and the mixture was stirred for 15-20 minutes. The pH was adjusted to 7 with HCl. The solution was spray dried to obtain a dry powder.

The obtained powder was dissolved in water to form a 1% (w/w) solution, which was clear and no precipitation occurred after 24 h. The powder was found to be 22-23% natamycin, of which more than 98% was completely soluble in water (complexed).

### Example 2, Reference Example

### Sausage and Cheese

Sausage and cheese slices were sprayed with
a) a natamycin dispersion containing 0, 50, 100, 150, 200, 300, 400, 500 and 750 ppm natamycin, and
b) a natamycin-cyclodextrin complex in aqueous solution containing 0, 50, 100, 150, 200, 300, 400, 500 and 750 ppm natamycin.

The spraying was performed so as to provide a minimum inhibitory dosage of 0.77 μg natamycin/cm² or more on the surface of the slices.

The antimicrobial activity on the sausage and cheese slices was analyzed after 6 days of incubation at 25° C./80% RH. The readings did not show significant variations between the two formulations (with and without cyclodextrin) on sausages or cheese.

At the dosages in question, any reduction of the mould growth caused by the complexation should have been confirmed. This was, however, not the case.

### Example 3

### Tortillas

A gamma-cyclodextrin-natamycin solution was produced employing a high pH system and the obtained solution was spray dried. Tortillas were treated with a standard natamycin (Natamax® SF) treatment, the spray-dried gamma-cyclodextrin-natamycin product, and traditional chemical preservatives to assess relative antifungal efficacy in baked goods.

Sample Variables in the Tortilla Treatments:
1. Control—Deionized Water
2. Control—Gamma-cyclodextrin (0.5% solution)
3. Traditional Chemical Preservatives (fumarate, sorbate, propionate)
4. Natamax® SF (target of ˜12 ppm natamycin on finished product)
5. Gamma-cyclodextrin-natamycin powder (target of ˜12 ppm natamycin on finished product)
6. Gamma-cyclodextrin-natamycin powder (target of ˜6 ppm natamycin on finished product)

For the spray application, each of the solutions were sprayed on 36 tortillas (about seven inches in diameter) using roughly the same spray volume. The tortillas were held on standard storage racks at 21.7° C. and monitored 0 to 30 days for mould growth. The tortilla application data is presented in Table 1 below.

TABLE 1
Tortilla application data

| Variable | Avg. ppm Natamycin on Tortillas | μg/cm² |
|---|---|---|
| 1 | 0.00 | 0.00 |
| 2 | 0.00 | 0.00 |
| 3 | 0.00 | 0.00 |
| 4 | 11.22 | 0.96 |
| 5 | 11.39 | 1.01 |
| 6 | 5.66 | 0.50 |

The shelf life data is presented in Table 2 as the number of moulded tortillas by sample variable.

TABLE 2
Shelf life data—Number of moulded tortillas (by variable).

| Day | 1 | 2 | 3 | 4 | 5 | 6 |
|---|---|---|---|---|---|---|
| 0 | 0 | 0 | 0 | 0 | 0 | 0 |
| 5 | 20 | 20 | 0 | 0 | 0 | 0 |
| 6 | 28 | 25 | 0 | 1 | 0 | 0 |
| 7 | 28 | 26 | 0 | 3 | 0 | 0 |
| 8 | 28 | 28 | 0 | 4 | 0 | 0 |
| 9 | 28 | 28 | 0 | 6 | 0 | 1 |
| 12 | 30 | 30 | 0 | 8 | 1 | 2 |
| 13 | 30 | 30 | 0 | 11 | 2 | 4 |
| 14 | 30 | 30 | 0 | 15 | 4 | 6 |
| 15 | 30 | 30 | 0 | 16 | 4 | 7 |
| 16 | 30 | 30 | 0 | 16 | 4 | 9 |
| 19 | 30 | 30 | 0 | 19 | 7 | 10 |
| 20 | 30 | 30 | 0 | 19 | 7 | 10 |
| 21 | 30 | 30 | 0 | 19 | 8 | 11 |
| 26 | 30 | 30 | 0 | 21 | 8 | 12 |
| 27 | 30 | 30 | 0 | 22 | 9 | 13 |
| 28 | 30 | 30 | 0 | 22 | 9 | 14 |
| 29 | 30 | 30 | 0 | 22 | 9 | 14 |
| 30 | 30 | 30 | 0 | 22 | 9 | 14 |

All of the variables treated with some form of preservative outlasted the two controls. Both of the controls showed visible signs of mould by day five and had reached full failure by day 12. The Natamax® SF variable showed the first signs of mould on day six and had 22 tortillas failed at 30 days. The spray dried gamma-cyclodextrin-natamycin variable at a low level (˜6 ppm natamycin) lasted eight days until the first appearance of mould and the higher treatment (˜11 ppm natamycin) lasted nine days until the first appearance of mould. These low and high gamma-cyclodextrin-natamycin variables had 14 and 9 tortillas failed at 30 days, respectively.

Both variables of natamycin that contained gamma-cyclodextrin extended the period of the first incidence of mould by a minimum of 3 days to 9 days total (versus lasting only 6 days for a standard natamycin treatment). Also, at the end of the study (Day 30), 100% of the Control treatments had failed, 61% of the tortillas treated with natamycin had failed, versus 25% of gamma-cyclodextrin-natamycin (treated at the same level of natamycin as the standard natamycin product), and 44% of the tortillas treated with half the rate of gamma-cyclodextrin-natamycin complexes were moulded (compared to the standard natamycin treatment).

Natamycin formulated with cyclodextrins can offer an enhanced antifungal capacity over a traditional natamycin treatment. Using cyclodextrins, the overall amount of natamycin on the finished product can be drastically reduced, potentially by three fold or greater. Also, this study demonstrates that natamycin-cyclodextrin complexes formed in a high pH aqueous system and processed through spray-drying equipment will still impart functional effects on a finished product.

### Example 4

### Tortillas

Natamycin was formulated according to the invention (1500 ppm natamycin with 5% gamma-cyclodextrin). Stock solutions were prepared one day in advance and stored overnight (20-22 hours) on a mixer or shaker at 3-6° C. The different natamycin solutions were prepared by diluting the stock solutions.

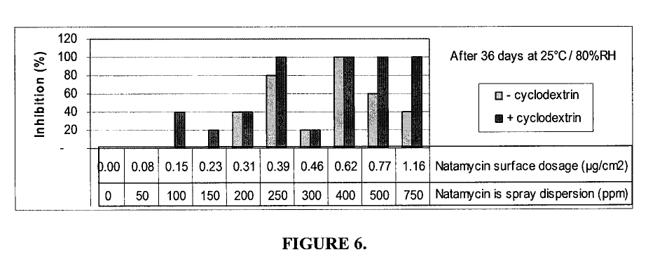

The antimicrobial activity on tortilla was analyzed after 12, 21, 28, and 36 days of incubation at 25° C./80% RH. Growth was only observed with mould Eurotium ssp. (DCS1099). The natamycin was applied through spraying with dispersions/solutions of various concentrations: 0, 50, 100, 150, 200, 250, 300, 400, 500 and 750 ppm. The results of the inhibitory activity are presented in FIGS. 3 to 6, wherein the figures show natamycin inhibition results on tortillas after 12, 21, 28 and 36 days, respectively, at 25° C. and 80% RH. In the figures □-cyclodextrin represents pure natamycin (non-complexed) and □+cyclodextrin represents natamycin formulated with cyclodextrin. The numbers on the first row in every figure is the natamycin surface dosage (μg/cm²). The numbers on the second row in every figure is the amount of natamycin in the dispersion/solution (ppm).

The figures show that the readings after 28 and 36 days indicated an improved effect of natamycin formulated with cyclodextrin compared to pure natamycin, especially at the two highest levels tested (0.77-1.16 μg natamycin/cm²) which was applied through spray with 500 and 750 ppm dispersion/solution, and where full inhibition was provided only on the tortilla sprayed with the cyclodextrin-formulated natamycin solutions. The overall picture was that better inhibition was provided with cyclodextrin-formulated natamycin compared to non-formulated natamycin.

The invention is further described by the following numbered paragraphs:

1. A process for improving the preservation of a bakery product by natamycin, which process comprises the steps wherein
a composition comprising natamycin in the form of a natamycin-cyclodextrin complex is provided, and
said composition is applied onto said bakery product as an antifungal agent.

2. The process of paragraph 1, wherein said composition is applied from an aqueous solution provided by dissolving a spray dried composition in water.

3. The process of paragraph 1, wherein said composition is applied onto said bakery product in an effective antifungal amount which includes 0.1 g/cm² or more, preferably 0.1 to 7.0 μg/cm², most preferably 0.2 to 0.9 μg/cm² natamycin on the surface of said bakery product.

4. The process of any one of the paragraphs 1 to 3, wherein said composition is applied onto said bakery product after baking.

5. The process of 4, wherein the temperature of the baked bakery product is not lower than 50° C. when said composition is applied.

6. The process of any one of the paragraphs 1 to 3, wherein said composition is applied onto said bakery product in the form of a pan oil or grease containing said composition.

7. A bakery product comprising an effective antifungal amount of natamycin in the form of a composition comprising a natamycin-cyclodextrin complex on the surface thereof.

8. The bakery product of paragraph 7, wherein the amount of natamycin on the surface of said bakery product is 0.1 μg/cm² or more, preferably 0.1 to 7.0 μg/cm², most preferably 0.2 to 0.9 μg/cm².

9. An antifungal natamycin composition with a modified antifungal activity and wherein said natamycin is in the form of a natamycin-cyclodextrin complex which is formed through dissolving cyclodextrin and natamycin in an aqueous solution, causing complexation between said cyclodextrin and natamycin, whereafter the thus formed composition is optionally recovered and processed to a powder through spray drying.

10. The composition according to paragraph 9, wherein the cyclodextrin in said natamycin-cyclodextrin complex comprises beta- and/or gamma-cyclodextrin, preferably gamma-cyclodextrin.

11. The composition according to paragraph 9 or 10, wherein the pH value of the aqueous solution in the complexation step is in the range of 8 or higher, preferably 8 to 13, more preferably 8 to 12.

12. The composition according to paragraph 9 or 10, wherein the pH value of the aqueous solution in the complexation step is in the range of 6 or lower, preferably 1 to 4.

13. The composition according to paragraph 11 or 12, wherein the pH value of the aqueous solution is adjusted to a pH value in the range of 6 to 8 after the complexation.

14. The composition according to any one of the preceding paragraphs 9 to 11, wherein the temperature of the aqueous solution in the complexation step of said cyclodextrin and natamycin is 0 to 100° C., preferably 15 to 30° C.

15. The composition according to any of the preceding paragraphs, wherein said spray dried powder comprising the natamycin-cyclodextrin composition comprises over 10 weight-% natamycin, preferably 10-25 weight-% natamycin, more preferably 12-20 weight-% natamycin.

16. A process for modifying the antifungal activity of natamycin which process comprises the steps of

a. dissolving cyclodextrin and natamycin in an aqueous solution,

b. causing complexation between said cyclodextrin and said natamycin to provide natamycin-cyclodextrin complexes,

c. optionally recovering a composition comprising said natamycin-cyclodextrin complexes from said aqueous solution, and

d. processing said composition comprising said natamycin-cyclodextrin complexes to a powder through spray drying.

17. The process of paragraph 15, wherein the pH value in step b. is in the range of 8 or higher, preferably 8 to 13, more preferably 8 to 12.

18. The process of paragraph 16, wherein the pH value in step b. is in the range of 6 or lower, preferably 1 to 4.

19. The process of paragraph 18, wherein the pH value of the solution formed in step b. is adjusted to the range of 6 to 8 after the complexation.

20. The process according to any one of the paragraphs 16 to 19, wherein the temperature in step b. is 0 to 100° C. preferably 15 to 30° C.

21. Use of the spray dried natamycin-cyclodextrin composition according to any one of the paragraphs 9 to 14 as an antifungal agent for the preservation of food products.

22. The use according to paragraph 21, wherein the food product is a bakery product.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

1. A process for improving the preservation of a bakery product by natamycin, which process comprises the steps wherein
a composition comprising natamycin in the form of a natamycin-cyclodextrin complex is provided, and
said composition is applied onto said bakery product as an antifungal agent.

2. The process of claim 1, wherein said composition is applied from an aqueous solution provided by dissolving a spray dried composition in water.

3. The process of claim 1, wherein said composition is applied onto said bakery product in an effective antifungal amount which includes 0.1 μg/cm² or more, preferably 0.1 to 7.0 μg/cm², most preferably 0.2 to 0.9 μg/cm² natamycin on the surface of said bakery product.

4. The process of claim 1, wherein said composition is applied onto said bakery product after baking.

5. The process of 4, wherein the temperature of the baked bakery product is not lower than 50° C. when said composition is applied.

6. The process of claim 1, wherein said composition is applied onto said bakery product in the form of a pan oil or grease containing said composition.

7. A bakery product comprising an effective antifungal amount of natamycin in the form of a composition comprising a natamycin-cyclodextrin complex on the surface thereof.

8. The bakery product of claim 7, wherein the amount of natamycin on the surface of said bakery product is 0.1 μg/cm² or more, preferably 0.1 to 7.0 μg/cm², most preferably 0.2 to 0.9 μg/cm².

9. An antifungal natamycin composition with a modified antifungal activity and wherein said natamycin is in the form of a natamycin-cyclodextrin complex which is formed through dissolving cyclodextrin and natamycin in an aqueous solution, causing complexation between said cyclodextrin and natamycin, whereafter the thus formed composition is optionally recovered and processed to a powder through spray drying.

10. The composition according to claim 9, wherein the cyclodextrin in said natamycin-cyclodextrin complex comprises beta- and/or gamma-cyclodextrin, preferably gamma-cyclodextrin.

11. The composition according to claim 9, wherein the pH value of the aqueous solution in the complexation step is in the range of 8 or higher, preferably 8 to 13, more preferably 8 to 12.

12. The composition according to claim 9, wherein the pH value of the aqueous solution in the complexation step is in the range of 6 or lower, preferably 1 to 4.

13. The composition according to claim 11, wherein the pH value of the aqueous solution is adjusted to a pH value in the range of 6 to 8 after the complexation.

14. The composition according to claim 9, wherein the temperature of the aqueous solution in the complexation step of said cyclodextrin and natamycin is 0 to 100° C., preferably 15 to 30° C.

15. The composition according to claim 9, wherein said spray dried powder comprising the natamycin-cyclodextrin composition comprises over 10 weight-% natamycin, preferably 10-25 weight-% natamycin, more preferably 12-20 weight-% natamycin.

16. A process for modifying the antifungal activity of natamycin which process comprises the steps of
a. dissolving cyclodextrin and natamycin in an aqueous solution,
b. causing complexation between said cyclodextrin and said natamycin to provide natamycin-cyclodextrin complexes,
c. optionally recovering a composition comprising said natamycin-cyclodextrin complexes from said aqueous solution, and
d. processing said composition comprising said natamycin-cyclodextrin complexes to a powder through spray drying.

17. The process of claim 15, wherein the pH value in step b. is in the range of 8 or higher, preferably 8 to 13, more preferably 8 to 12.

18. The process of claim 16, wherein the pH value in step b. is in the range of 6 or lower, preferably 1 to 4.

19. The process of claim 18, wherein the pH value of the solution formed in step b. is adjusted to the range of 6 to 8 after the complexation.

20. The process according to claim 16, wherein the temperature in step b. is 0 to 100° C. preferably 15 to 30° C.
